(19) United States
(12) Patent Application Publication
(10) Pub. No.: US 2026/0268025 A1
(43) Pub. Date: Sep. 10, 2026

(54) Authenticated Images

(71) Applicant: Apple Inc., Cupertino, CA (US)

(72) Inventors: Geoffrey Stahl, Littleton, CO (US); Michael J Rockwell, Palo Alto, CA (US)

(73) Assignee: Apple Inc., Cupertino, CA (US)

(21) Appl. No.: 19/557,480

(22) Filed: Mar. 5, 2026

Related U.S. Application Data
(60) Provisional application No. 63/768,533, filed on Mar. 7, 2025.

(51) Int. Cl. G06F 21/64; G06F 21/78; G06T 7/50; H04L 9/32

(52) U.S. Cl. CPC G06F 21/64; G06F 21/78; G06T 7/50; H04L 9/3213; H04L 9/3236; H04L 9/3247

(57) ABSTRACT

Image authentication is performed by generating a copy of a captured image in an operating system (OS) layer inaccessible to applications and forwarding the copy of the captured image to a secure storage repository via a secure communication channel between the OS layer and the secure storage repository. A user can later present an identifier for the image at a cloud network hosting the secure storage repository and be provided a visual representation of the copy of the captured image. If the provided representation matches a shared version of the captured image it can be verified that the shared version is authentic representation of the originally captured image. If they differ, it can be inferred that the shared version has been altered or is otherwise not authentic.

### PRIORITY CLAIM

This application claims benefit of priority to U.S. Provisional Application Serial No. 63/768,533, entitled “Authenticated Images,” filed Mar. 7, 2025, and which is incorporated herein by reference in its entirety.

### BACKGROUND

### Technical Field

This disclosure relates generally to authentication of images captured via an image capture device, for example to authenticate that the images were not generated by artificial intelligence.

### Description of the Related Art

As generative models continue to improve in performance and capabilities, differentiating authentic images captured by real-world image capture devices and artificially generated images, such as those generated using generative models or other software, has become increasingly difficult. For example, generative models are increasingly capable of generating images that appear as though they represent real-world scenes and events. To address this issue, some systems attach a certificate or other metadata to images for use in authenticating that the images were captured by a real-world image capture device. However, in various circumstances, such certificates or metadata may be spoofed or otherwise manipulated, thus causing guarantees of authenticity to be put in doubt.

### SUMMARY OF EMBODIMENTS

In some embodiments, a mobile electronic device, such as a phone, tablet, AR/VR headset, etc., includes a camera, image signal processor, and additional processors and memory that implement an operating system (OS) on the mobile electronic device. The operating system implements a secure enclave interface, at an OS layer, inaccessible to applications that run on the OS. The secure enclave interface connects to a secure enclave, implemented in hardware, that is configured to directly receive image data from the image signal processor, before the image data is exposed to applications at an application layer above the OS layer. The image data received at the secure enclave is copied in the secure enclave, and a first copy of the image data is forwarded to a remote secure storage repository via a secure communication channel that connects to the secure enclave interface implemented at the OS layer. For example, a cloud network may include computing devices and storage devices that implement the secure storage repository and that are connected to the secure enclave interface of the mobile electronic device using one or more secure communication channels. The copied image data is appended, in the secure enclave, with an identifier prior to being forwarded to the secure storage repository. Also, a second copy of the image data is provided to the application layer has the same identifier appended to it. The first copy sent to the secure storage repository is sent via the secure communication channel between the secure enclave interface at the OS layer of the mobile device operating system and the secure storage repository.

Subsequent to the storage of the first copy of the image data in the secure storage repository, the owner of the image data, or an authorized third-party, may present the identifier and appropriate credentials, and, in response, be provided a representation of the originally captured and stored image data. The owner (or third-party) may compare the representation generated using the originally captured and stored image data to a current image claimed to be an authentic representation of the originally captured image. If the two substantially match, then the current image may be considered an authentic version of the originally captured image. In contrast, if the two do not match, it may be inferred that the current image is not an authentic representation of the originally captured image. For example, the current image may have been modified using artificial intelligence, photo editing software, etc. Also, the current image may not be a true representation of what it is claimed to be a representation of. For example, the current image may be an image generated using artificial intelligence instead of a real-world image captured by an image sensor.

In some embodiments, a cloud-based system includes storage devices that implement a secure storage repository and one or more computing devices configured to receive from a mobile electronic device, via a secure communication channel, a copy of data captured by a camera of the mobile electronic device, wherein the secure communication channel connects the one or more computing devices to the mobile electronic device at an OS layer below an application layer such that the secure communication channel is not accessible to applications executing on the mobile electronic device. In some embodiments, the computing devices are further configured to receive authentication requests from authorized users, wherein the authentication requests include an identifier for a given image stored in the secure storage repository. In response to determining a user submitting the authentication request has valid credentials to perform authentication, the one or more computing devices of the cloud-based system are configured to provide the user with a representation of the originally captured image data that has been stored in the secure storage repository. In some embodiments, the cloud-based computing system further includes computing devices that store image data that is accessible to a user for editing. However, the image data stored in the secure storage repository is not editable, and therefore can be used to authenticate images as being authentic images captured by an image capture device of a mobile electronic device, such as a phone, tablet, AR/VR headset, etc.

In some embodiments, a non-transitory, computer-readable storage medium stores program instructions that, when executed using one or more processors, cause the one or more processors to forward image data and an appended identifier to a secure storage repository, wherein the image data and the appended identifier are forwarded to the secure storage repository using a secure communication channel implemented at an OS layer below an application layer such that the secure communication channel is not accessible to applications executing at the application layer.

In some embodiments, a non-transitory, computer-readable storage medium stores program instructions that, when executed using one or more processors, cause the one or more processors to receive from a mobile electronic device, via a secure communication channel, a copy of data captured by a camera of the mobile electronic device, wherein the secure communication channel connects the one or more computing devices to the mobile electronic device at an OS layer below an application layer such that the secure communication channel is not accessible to applications executing on the mobile electronic device. The program instructions further cause the one or more processors to cause the copy of the data captured by the camera of the mobile electronic device to be stored in the secure storage repository. Additionally, the program instructions cause the one or more processors to provide, in response to an authentication request, a representation of the stored copy of the data captured by the camera.

### BRIEF DESCRIPTION OF THE DRAWINGS

FIG. 1 illustrates a cloud network that implements a secure storage repository and also illustrates a mobile electronic device that implements a secure enclave and secure enclave interface at an operating system layer, wherein the secure enclave receives image data from an image signal processor of the mobile electronic device, generates a copy of the image data before it is made accessible to applications at an application layer of the mobile electronic device, and sends the copy of the image data and an associated identifier to the secure storage repository implemented in the cloud network, according to some embodiments.

FIG. 2 illustrates the image data from the image signal processor being copied in the secure enclave, wherein a first copy is forwarded to the secure storage repository via the secure communication channel and is not editable, and wherein a second copy is stored to a local storage of the mobile electronic device and is available to be edited and/or shared, according to some embodiments.

FIG. 3 illustrates an example user interface of a mobile electronic device, wherein a user may opt-in to enabling images to be authenticated by the owner of the image or an authorized third-party, wherein authentication is performed by allowing the owner or third-party to view a representation of image data copied and stored to a secure storage repository directly from the image signal processor of the mobile electronic device, according to some embodiments.

FIG. 4 illustrates additional components that may be included in a secure enclave, such as an authentic image verification agent, identifier attachment engine, and an additional metadata attachment engine, according to some embodiments.

FIG. 5 illustrates additional details regarding an example configuration of an authentic image verification agent, according to some embodiments.

FIG. 6 illustrates a cloud network that includes a secure storage repository and associated applications for accepting image data into the secure storage repository as well as providing representations of the stored image data in response to authentication requests, wherein the cloud network also includes an additional cloud image repository and associated applications for providing access and editing capabilities for images stored in the cloud image repository, according to some embodiments.

FIG. 7 illustrates an input image gatekeeping engine that may be included in a cloud network, wherein the input image gatekeeping engine verifies a token associated with received image data matches encryption material provided to the mobile electronic device for use in generating tokens, wherein if the token matches the provided encryption material it can be affirmed that the image data was captured by the particular mobile electronic device, according to some embodiments.

FIG. 8 illustrates an access directory updater that may be included in a cloud network, wherein the access directory updater receives sharing updates, sharing preferences, and/or social media relationship information and uses these received items of information to update a directory of which entities, and with which credentials, are authorized to use the image authentication features of the cloud network for which images, according to some embodiments.

FIG. 9 illustrates tokens being appended to image data being forwarded via a secure communication channel between a secure enclave of a mobile electronic device and a secure storage repository of a cloud network, according to some embodiments.

FIG. 10 is a flowchart illustrating operations performed at a mobile electronic device to generate copies of image data captured by an image sensor and to provide the copied image data to a secure storage repository of a cloud network, according to some embodiments.

FIG. 11 is a flowchart illustrating operations performed by an authentic image verification agent of a secure enclave to reject image data that is deemed to not represent an image capture of a real-world scene or object, according to some embodiments.

FIG. 12 is a flowchart illustrating operations performed by a cloud network implementing a secure storage repository, according to some embodiments.

FIG. 13 is a flowchart illustrating operations to update an access directory for a secure storage repository of a cloud network, according to some embodiments.

FIG. 14 is a flowchart illustrating operations performed at a secure storage repository to create a hash of stored image data and to use the hash to verify that the stored image data has not been altered, according to some embodiments.

FIG. 15 illustrates a schematic representation of an example mobile electronic device that may include a camera, in accordance with some embodiments.

FIG. 16 is a diagram illustrating example applications for systems and devices implementing functionality as described herein.

FIG. 17 illustrates an example computer system that may be included in a mobile electronic device and/or cloud network, according to some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units ….” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112(f), for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

### DETAILED DESCRIPTION

In some embodiments, a mobile electronic device, such as a phone, tablet, AR/VR headset, etc., includes a camera, image signal processor, and additional processors and memory that implement an operating system (OS) on the mobile electronic device. The mobile electronic device also includes hardware that implements a secure enclave. For example, a system on a chip (SoC) included in the mobile electronic device may include an application processor and memory controller that controls memory used by the operating system and applications as well as a secure enclave processor and memory protection engine that controls a protected portion of the memory used by the secure enclave. The operating system implements a secure enclave interface, at an OS layer, inaccessible to applications that run on the OS. The secure enclave is configured to directly receive image data from the image signal processor, before the image data is exposed to applications at an application layer above the OS layer. The image data received at the secure enclave is copied in the secure enclave, and a first copy of the image data is forwarded to a remote secure storage repository via a secure communication channel that connects to the secure enclave interface. For example, a cloud network may include computing devices and storage devices that implement the secure storage repository and that are connected to the secure enclave of the mobile electronic device using one or more secure communication channels to the secure enclave interface. The copied image data is appended with an identifier prior to being forwarded to the secure storage repository. Also, a second copy of the image data that is provided to the application layer has the same identifier appended to it. The first copy sent to the secure storage repository is sent via the secure communication channel between the secure enclave interface at the OS layer of the mobile device operating system and the secure storage repository.

Subsequent to the storage of the first copy of the image data in the secure storage repository, the owner of the image data ,or an authorized third-party, may present the identifier and appropriate credentials, and, in response, be provided a representation of the originally captured and stored image data. The owner (or third-party) may compare the representation generated using the originally captured and stored image data to a current image claimed to be an authentic representation of the originally captured image. If the two substantially match, then the current image may be considered an authentic version of the originally captured image. In contrast, if the two do not match, it may be inferred that the current image is not an authentic representation of the originally captured image. For example, the current image may have been modified using artificial intelligence, photo editing software, etc. Also, the current image may not be a true representation of what it is claimed to be a representation of. For example, the current image may be an image generated using artificial intelligence instead of a real-world image captured by an image sensor.

In some embodiments, the identifier appended to the copy of the image data stored to the secure storage repository may be a watermark or may otherwise be embedded in the image or otherwise appended to the image data in the secure enclave. In some embodiments, the identifier may be globally unique as compared to other identifiers appended to other image data to be stored in the secure storage repository. Additionally, in some embodiments, the identifier may indicate a type of mobile electronic device that captured the image data, such as the manufacturer of the mobile electronic device. In some embodiments, the secure storage repository may only accept images from a given type of device that the secure storage repository was designed to interact with. This may provide added security because a single entity is in control of the software used to implement the secure enclave, etc. In some embodiments, a same entity, such as the manufacturer of the mobile electronic device and an operator of the cloud network, may provide both the mobile electronic device and control the cloud network. Thus, images captured by the mobile electronic device that are stored in the secure storage repository may be retained in a common eco-system managed by the same entity. In this way, consumers may rely on the provider of the mobile electronic device and the operator of the cloud network to implement security protocols to ensure image data copied from the image signal processor is copied and stored without meaningful modification and can therefore be trusted and later used as a reference to determine the authenticity of images.

In some embodiments, a cloud-based system includes storage devices that implement a secure storage repository and one or more computing devices configured to receive from a mobile electronic device, via a secure communication channel, a copy of data captured by a camera of the mobile electronic device, wherein the secure communication channel connects the one or more computing devices to the mobile electronic device at an OS layer below an application layer such that the secure communication channel is not accessible to applications executing on the mobile electronic device. In some embodiments, the computing devices are further configured to receive authentication requests from authorized users, wherein the authentication requests include an identifier for a given image stored in the secure storage repository. In response to determining a user submitting the authentication request has valid credentials to perform authentication, the one or more computing devices of the cloud-based system are configured to provide the user with a representation of the originally captured image data that has been stored in the secure storage repository. In some embodiments, the cloud-based computing system further includes computing devices that store image data that is accessible to a user for editing. However, the image data stored in the secure storage repository is not editable, and therefore can be used to authenticate images as being authentic images captured by an image capture device of a mobile electronic device, such as a phone, tablet, AR/VR headset, etc.

In some embodiments, a user interface of a mobile electronic device enables users to adjust settings regarding whether a stored copy of image data for a given image is to be provided for authentication. For example, in some embodiments, while image authentication is selected to be active on the mobile electronic device, image data for each image capture may be forwarded to the secure storage repository in the cloud network. Initially the settings for the forwarded image data may not allow sharing for authentication. However, a user of the mobile electronic device or owner of the image data may subsequently decide to “turn on” authentication by allowing other parties to view the stored copies of the image data in order to authenticate other copies of the image data that have been shared with the third parties. For example, a user of the mobile electronic device may “turn on” authentication sharing when providing the image to others or uploading the image for public viewing, such as on social media. This allows other parties that view the image to verify its authenticity. In some embodiments, various controls may be put in place regarding who can view the copy of the image data stored in the secure storage repository for authentication purposes. For example, a user may limit authentication sharing only to listed parties with which the user has shared the image. In other situations, the user may enable authentication sharing more generally to the public. Also, in some embodiments, the user may provide a preference that limits authentication sharing to only other third parties that have a specified relationship to the user, such as may be indicated in social media relationship information. For example, authentication sharing may be limited to “friends” or “followers” of the user.

In some embodiments, the secure enclave may further implement a verification agent to verify the authenticity of image data before further processing the image data in the secure enclave. For example, the verification agent may verify that the image data was generated by a type of image sensor known to be installed in the mobile electronic device. Also, the verification agent may use depth information to ensure that the image data is for an image of a real-world scene (as compared to an image capture of an AI generated image). For example, the verification agent may determine a depth model for objects or scenes represented in the image data and may compare depth information of the determined depth model to depth information for the scene captured by other sensors of the mobile electronic device when capturing the image, such as a LiDAR sensor of the mobile electronic device. If the depths represented in the depth model substantially match the depths measured using the other sensors of the mobile device it may be verified that the image data is related to an image capture of a real-world scene. For example, an image captured of a screen displaying an AI generated image would have a flat depth, such that the depth determined using the depth model (which would show varying depths) would not substantially match the depth measurements of the other sensors of the mobile electronic device (e.g. showing a flat depth corresponding to a screen).

Additionally, in some embodiments, the cloud network may generate snapshots or other archived copies of image data stored in the secure storage repository. Thus, in some embodiments, the archived versions of the secure storage repository may further be viewed to verify that the image data has not been altered while stored in the secure storage repository. Also, a hash of the image data may be generated when initially stored in the secure storage repository and later used to verify that the image data has not been changed since initially stored in the secure storage repository. In some embodiments, a hash may be generated in the secure enclave of the mobile electronic device and may be stored with the image data in the secure storage repository for later use in verifying that the image data has not been altered.

In some embodiments, other metadata may be stored with the image data in the secure storage repository. For example, metadata identifying the mobile electronic device that captured the image, metadata indicating a date and/or time the image was captured, metadata indicating a geographic location (e.g., GPS location) where the image was captured, etc. may be stored with the image data in the secure storage repository and later used for authentication.

In some embodiments, the image data may be for images included in various types of media content, such as images, videos, volumetric (e.g. 3D) visual content, etc.

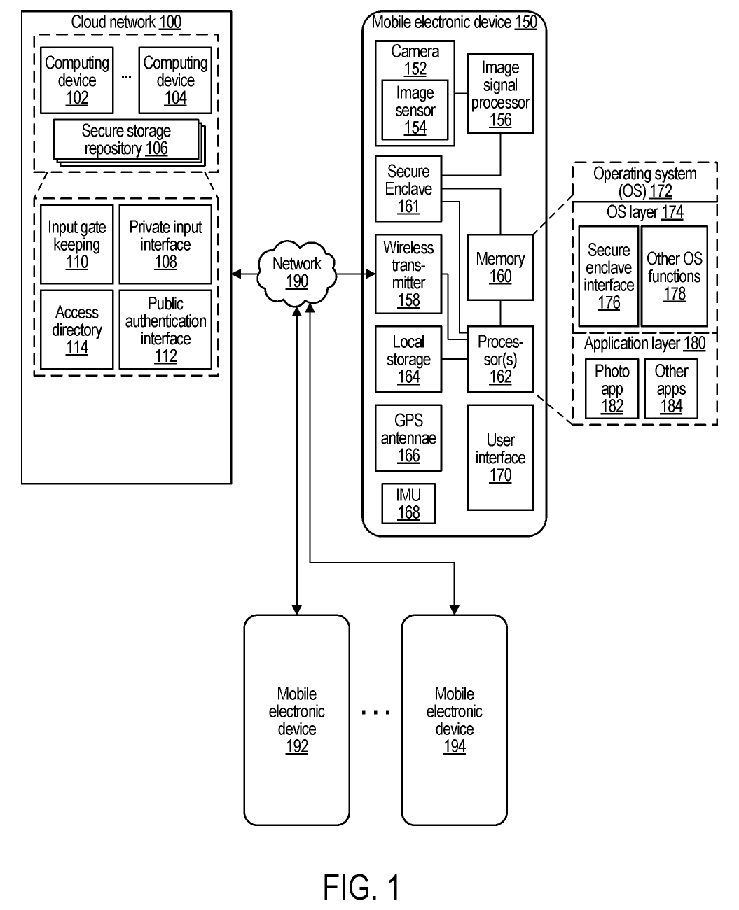

FIG. 1 illustrates a cloud network that implements a secure storage repository and also illustrates a mobile electronic device that implements a secure enclave and a secure enclave interface at an operating system layer, wherein the secure enclave receives image data from an image signal processor of the mobile electronic device, generates a copy of the image data before it is made accessible to applications at an application layer of the mobile electronic device, and sends, via the secure enclave interface, the copy of the image data and an associated identifier to the secure storage repository implemented in the cloud network, according to some embodiments.

In some embodiments, a secure image storage eco-system, such as shown in FIG. 1, includes a cloud network 100 and one or more mobile electronic devices, such as mobile electronic devices 150, 192, and 194. Respective ones of the mobile electronic devices (e.g., mobile electronic device 192 and 194) may include components such as shown for mobile electronic device 150. The secure image storage eco-system enables copies of images to be securely stored when captured and saved for later use to authenticate other copies of the images, which are shared.

For example, mobile electronic device 150 includes one or more cameras 152, each comprising an image sensor, such as image sensor 154. Image signals generated by image sensor 154 are sent to image signal processor 156 for conversion into image data, e.g. data that can be stored and used to render a captured image. The image data is then provided to secure enclave 161, and copies generated in the secure enclave are provided to memory 160 via secure enclave interface 176. The memory 160 stores program instructions for implementing an operating system (OS) 172 on the mobile electronic device 150 using the memory 160 and the one or more processors 162. More specifically, the program instructions stored in the memory 160 cause the one or more processors 162 to implement secure enclave interface 176 in the OS layer 174 along with other OS layer functions 178. Additionally, the program instructions cause the one or more processors 162 to implement other applications, such as a photo application 182 and/or other applications 184 at an application layer 180 that executes above the OS layer 174. Data, such as captured image data and/or image metadata being processed in the secure enclave 161 and provided to the secure enclave interface 176 is not accessible to applications in the application layer 180, such as photo application 182 and other applications 184. For example, the applications cannot read or write to the secure enclave 161 and are generally unaware that the secure enclave interface 176 is implemented in the OS layer 172. Note by placing the secure enclave interface 176 in the OS layer 174, the secure enclave 161 is isolated from users and user applications of the mobile electronic device 150. Thus, malicious application code and/or other malefactors cannot access the image data in the secure enclave and are therefore prevented from being able to manipulate the image data.

In some embodiments, wireless transmitter 158 implements a secure communication channel between secure enclave interface 176 and private input interface 108 of cloud network 100. For example, cloud network 100 includes computing devices 102 through 104 and storage devices that implement secure storage repository 106. Additionally, the computing devices 102 through 104 implement private input interface 108, input gate keeping engine 110, public authentication interface 112 and access directory 114.

In some embodiments, a secure communication channel is formed between secure enclave interface 176 and private input interface 108 via wireless transmitter 158 and network 190. In some embodiments, network 190 may include various wireless and/or wired networks, such as cellular networks, public networks (e.g. the Internet), and/or private networks, such as a network operated by an operator or owner of cloud network 100. In some embodiments, the secure communication channel may include one or more encrypted communication links, such as virtual private network (VPN) links or other suitable cryptographically protected network link. In some embodiments, endpoints of the secure communication channel may be mapped to private input interface 108 and secure enclave interface 176.

In some embodiments, private input interface 108 may not be publicly accessible, but instead may only be accessible from mobile electronic devices manufactured by an operator of cloud network 100, or otherwise approved by the operator of cloud network 100 to upload image data for use in performing image authentication.

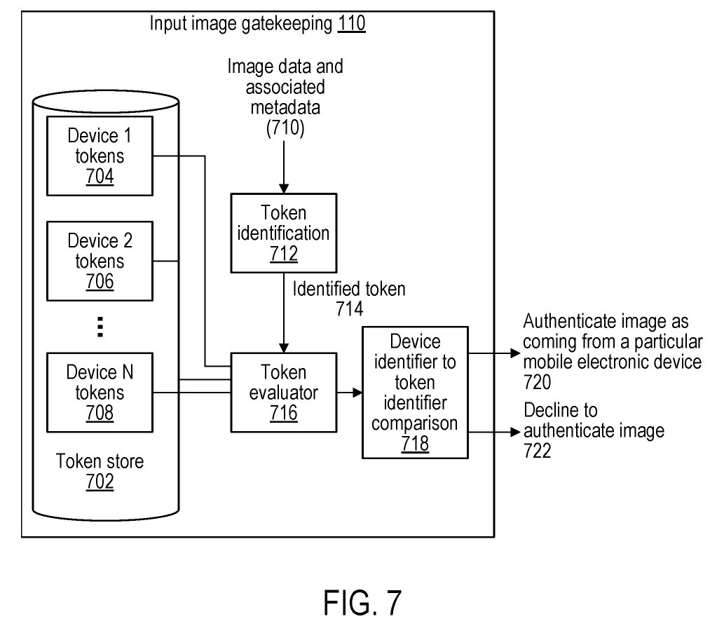

As further described in FIG. 7, input image gatekeeping engine 110 may verify an identity of a mobile electronic device providing image data for upload to secure storage repository 106 using cryptographic identifiers such as tokens generated using cryptographic material provided to the mobile devices, such as mobile device 150. In some embodiments, input gatekeeping engine 110 may also verify that mobile electronic device 150 is a type of mobile electronic device authorized to provide image data to be added to secure storage repository 106. For example, in some embodiments, only certain makes or models of mobile electronic devices, such as those manufactured by a same entity as the operator of cloud network 100, may be authorized to provide image data for upload to secure storage repository 106.

In some embodiments, public authentication interface 112 receives authentication requests, to authenticate images that have been shared with a requestor. For example, a second copy of an image (e.g., where the first copy was added to secure storage repository 106) may be stored in local storage 164, and may generally be shared, for example with other devices, websites, the Internet, etc. Recipients of the shared second copies of the image may desire to authenticate the shared second copies to verify that they are in fact authentic representations of an image captured by an image sensor and representing a real-world scene or object. For example, authentication may determine with a high degree of certainty whether the shared copies of the image are AI generated or significantly altered images. For example, a third party to which a second copy of an image is shared, may request to view the stored first copy of the shared image and compare the two copies to determine that the shared second copy is an authentic representation of the real-world scene or object shown in the first copy of the image.

In some embodiments, an access directory 114 may store access rights indicating which third-party entities are permitted to view representations of images stored in secure storage repository 106, for example to authenticate shared second copies of the images. In some embodiments, the access directory 114 may further include credential information indicating what credentials are required to be provided by the third-parties to prove their identities. Also, in some embodiments different access privileges may be associated with different types of credentials. For example, third-parties with higher level credentials may be able to view additional information about a stored image, such as image metadata, whereas third-parties with more limited credentials may only be allowed to view a representation of a stored image.

For example, in some embodiments other metadata may be appended to the image metadata in secure enclave 161 and forwarded on for storage in secure storage repository 106. For example, location metadata from GPS antennae 166 and/or inertial measurement unit (IMU) 168 may be appended to the image data. Also, OS data such as a date and/or time of capture of an image may be appended to the image in secure enclave 161 or secure enclave interface 176.

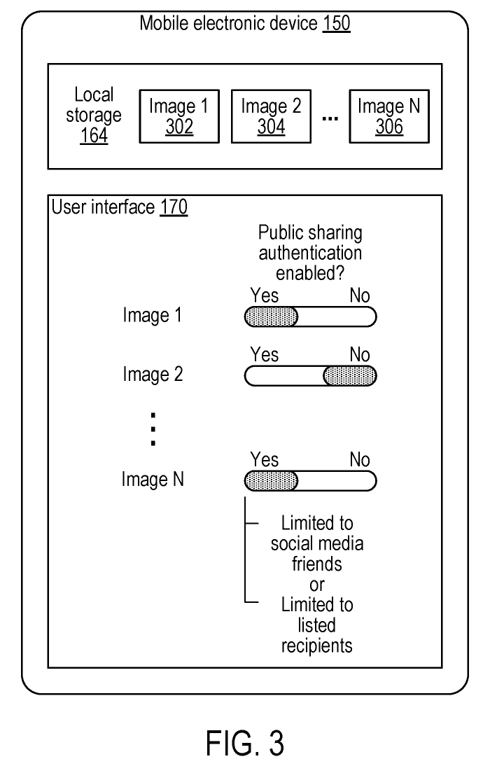

In some embodiments, mobile device 150 may further include one or more user interfaces 170, such as a touch screen display, heads up display and control, AR/VR display and controller, etc. For example, FIG. 3 illustrates an example view of a user interface 170 being used to allow a user of the mobile electronic device 150 to select whether sharing authorization is enabled for respective ones of a plurality of images having respective second copies stored in local storage 164 (and for which a first copy is stored in secure storage repository 106).

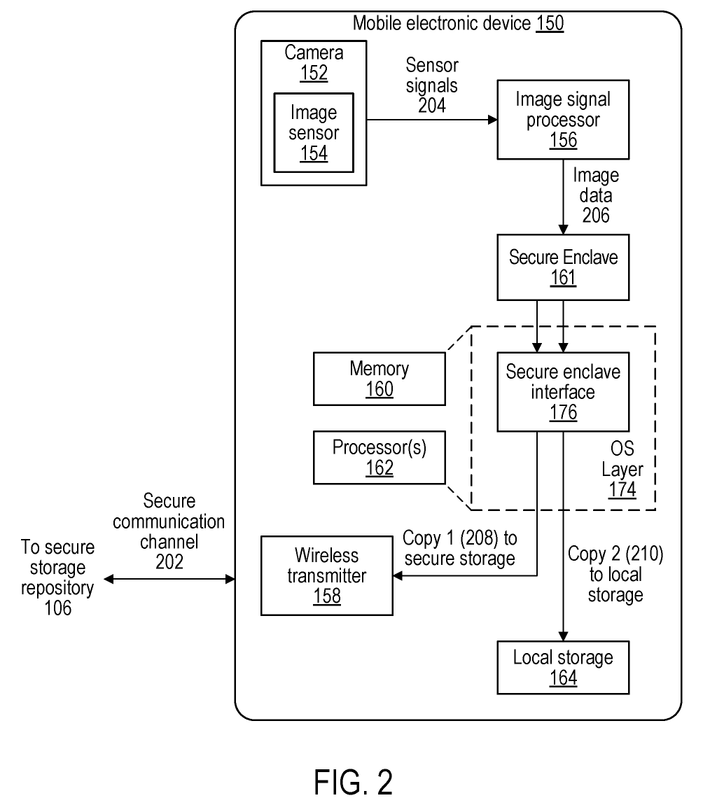

FIG. 2 illustrates the image data from the image signal processor being copied in the secure enclave, wherein a first copy is forwarded to the secure storage repository via the secure communication channel and is not editable, and wherein a second copy is stored to a local storage of the mobile electronic device and is available to be edited and/or shared, according to some embodiments.

As shown in FIG. 2, sensor signals 204 from image sensor 154 are sent to image signal processor 156, which converts the sensor signals 204 into image data 206 which is provided to secure enclave 161. In the secure enclave a first copy 208 is made of the image data 206, which is sent to secure repository 106 via secure enclave interface 176 and wireless transmitter 158 and secure communication channel 202. Also, a second copy 210 is stored to local storage 164 via secure enclave interface 176. In some embodiments local storage 164 is accessible to applications, such as photo application 182 and other applications 184 executing at application layer 108. In contrast, secure enclave 161, secure enclave interface176, and the path from image sensor 154 to image signal processor 156 to secure enclave 161 and on to secure enclave interface 176 and secure storage repository 106 via secure communication channel 202 are not accessible to the application layer 180. Also, the first copy of the image data 208 sent to the secure storage is not editable.

FIG. 3 illustrates an example user interface of a mobile electronic device, wherein a user may opt-in to enabling images to be authenticated by the owner of the image or an authorized third-party, wherein authentication is performed by allowing the owner or third-party to view a representation of image data copied and stored to a secure storage repository directly from the image signal processor of the mobile electronic device, according to some embodiments.

As an example, local storage 164 stores images 1 (302), 2 (304), and N (306). Also, user interface 170 allows users of mobile electronic device 150 to select authentication sharing permissions for the respective images. For example, image 1 (302) is authorized to be presented to third-parties presenting an identifier for image 1 and who are included in access directory 114 as being granted privileges to use public authentication interface 112. Also, in some embodiments, access directory 114 may store different access privileges for the same third-party for different ones of the images 1 (302), 2 (304), and N (306). For example, a given third party may be granted permission to view image 1 (302) for authentication but may not be granted permission to view image N (306). As another example image 2 (304) is not authorized to be presented to third-parties for authentication. However, a first copy of image 2 (304) may be stored in secure storage repository 106. Thus, a user of mobile electronic device 150 may later decide to share image 2 (304) and enable sharing for authentication.

As yet another example, public sharing for authentication is selected to be enabled for image N (306). However additional sharing configuration options are selected, wherein sharing for authentication is only enabled for social media friends and/or a list of entities with which a second copy of image N (306) has been shared.

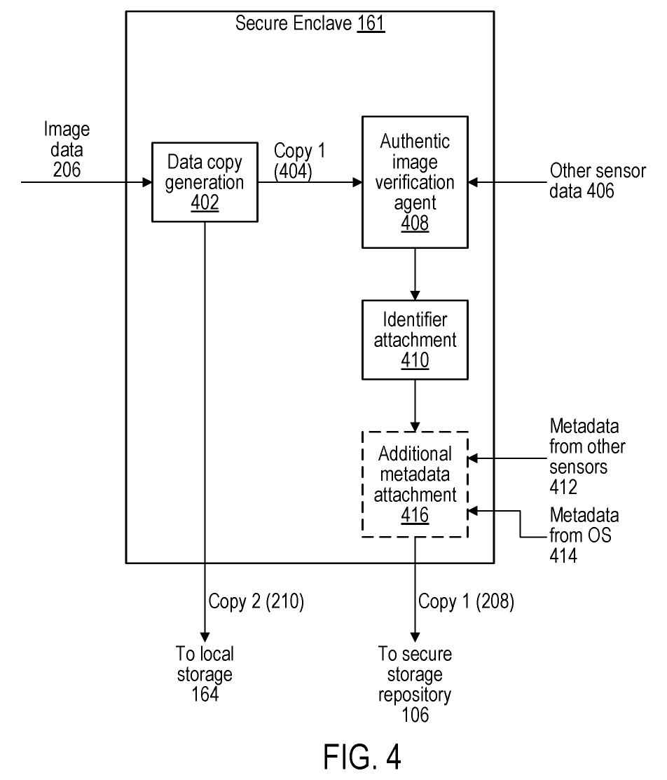

FIG. 4 illustrates additional components that may be included in a secure enclave, such as an authentic image verification agent, identifier attachment engine, and an additional metadata attachment engine, according to some embodiments.

In some embodiments, secure enclave 161 implements data copy generation 402, authentic image verification agent 408, identifier attachment engine 410 and additional metadata attachment engine 416.

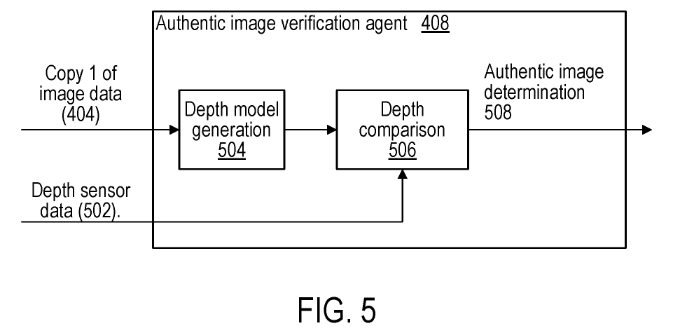

Image data 206 is received at data copy generation engine 402 and first and second copies (e.g., copy 1 (404) and copy 2 (210)) are generated. Copy 1 (404) is further evaluated by authentication image verification agent 408 using other sensor data to verify that image data 206 represents an actual real-world scene or object and not a picture of a picture of a scene or object (which avoids an AI picture being captured by camera 152 and being passed off as a real-world image capture of a scene). Additional details of how image verification is performed are provided in FIG. 5. Assuming the authentic image verification agent 408 determines the image data included in copy 1 (404) is authentic, the copy 1 (404) is forwarded on to identifier attachment engine 410, wherein a unique identifier is appended to the image data included in copy 1 (404). Optionally, additional metadata may be attached, via additional metadata attachment engine 416. For example, metadata from other sensors 412, such as metadata from GPS antennae 166, metadata from IMU 168, metadata from LiDAR sensor, etc. may be attached. Also, metadata 414 from OS 172 may be attached, such as a current date and/or time when the image was captured. The first copy of the image data and the attached metadata is provided to secure storage repository 106 as copy 1 (208) using secure communication channel 202, as described in FIG. 2.

FIG. 5 illustrates additional details regarding an example configuration of an authentic image verification agent, according to some embodiments.

As an example of image verification, in some embodiments authentic image verification agent 408 includes a depth model generation engine 504 and a depth comparison engine 506. Depth model generation engine 504 uses the image data 404 to estimate depths of objects in a scene of the image represented by image data 404. Additionally, depth sensor data 502, such as from a LiDAR sensor of mobile electronic device 150 is provided to depth comparison engine 506. If the estimated depths determined by depth model generation engine 504 match the depths indicated in depth sensor data 502 within a threshold amount, the images may be verified to be images of real-world scenes. If the estimated depths and the measured depths indicated in the depth sensor data 502 diverge by more than a threshold amount, then depth comparison engine 506 may refrain from forwarding the image data, as it is likely not authentic. Either way, depth comparison engine 506 provides an authentic image determination 508 indicating whether or not the image data included in image data 404 can be verified to be captured image data of a real-world scene or not.

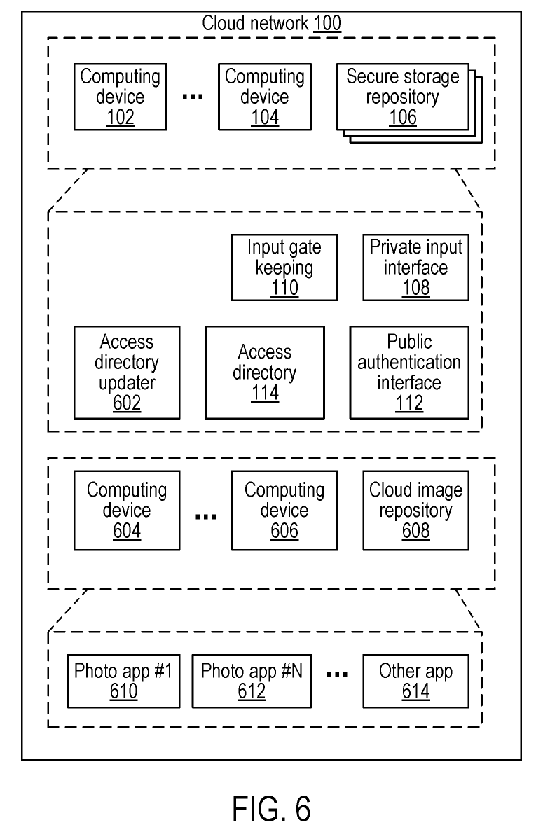

FIG. 6 illustrates a cloud network that includes a secure storage repository and associated applications for accepting image data into the secure storage repository as well as providing representations of the stored image data in response to authentication requests, wherein the cloud network also includes an additional cloud image repository and associated applications for providing access and editing capabilities for images stored in the cloud image repository, according to some embodiments.

In some embodiments, cloud network 100 may additionally implement a cloud image repository 608 and include computing devices 604 through 606 that implement applications that edit images stored in cloud image repository 608, such as photo application 1 (610), photo application N (612), and other apps 614. In some embodiments, first copy 208 is stored in secure storage repository 106 and is not editable, but second copy 210 is stored in cloud image repository 608 and is editable.

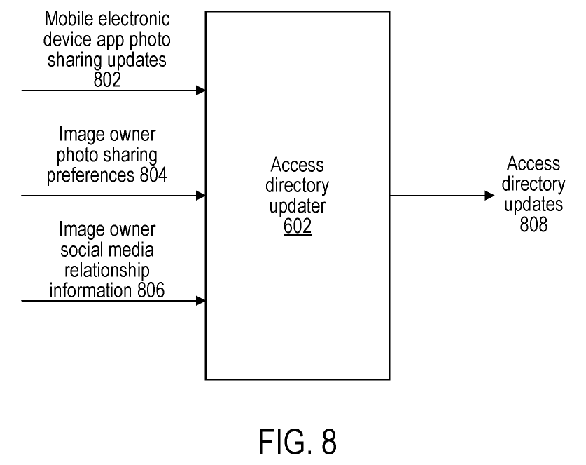

Also, cloud network 100 includes computing devices 102 through 104 and storage devices that implement secure storage repository 106. Additionally, the computing devices 102 through 104 implement private input interface 108, input gate keeping engine 110, public authentication interface 112 and access directory 114. Additionally, computing devices 102 through 104 implement access directory updater 602, which is described in more detail in FIG. 8.

In some embodiments, a secure communication channel is formed between secure enclave interface 176 and private input interface 108 via wireless transmitter 158 and network 190. In some embodiments, the secure communication channel may include one or more encrypted communication links, such as virtual private network (VPN) links or other suitable cryptographically protected network link. In some embodiments, endpoints of the secure communication channel may be mapped to private input interface 108 and secure enclave interface 176.

In some embodiments, private input interface 108 may not be publicly accessible, but instead may only be accessible from mobile electronic devices manufactured by an operator of cloud network 100, or otherwise approved by the operator of cloud network 100 to upload image data for use in performing image authentication.

As further described in FIG. 7, input image gatekeeping engine 110 may verify an identity of a mobile electronic device providing image data for upload to secure storage repository 106 using cryptographic identifiers such as tokens generated using cryptographic material provided to the mobile devices, such as mobile device 150. In some embodiments, input gatekeeping engine 110 may also verify that mobile electronic device 150 is a type of mobile electronic device authorized to provide image data to be added to secure storage repository 106. For example, in some embodiments, only certain makes or models of mobile electronic devices, such as those manufactured by a same entity as the operator of cloud network 100, may be authorized to provide image data for upload to secure storage repository 106.

In some embodiments, public authentication interface 112 receives authentication requests, to authenticate images that have been shared with a requestor. For example, a second copy of an image (e.g., where the first copy was added to secure storage repository 106) may be stored in local storage 164, and may generally be shared, for example with other devices, websites, the Internet, etc. Recipients of the shared second copies of the image may desire to authenticate the shared second copies to verify that they are in fact authentic representations of an image captured by an image sensor and representing a real-world scene or object. For example, authentication may determine with a high degree of certainty whether the shared copies of the image are AI generated or significantly altered images. For example, a third party to which a second copy of an image is shared, may request to view the stored first copy of the shared image and compare the two copies to determine that the shared second copy is an authentic representation of the real-world scene or object shown in the first copy of the image.

In some embodiments, an access directory 114 may store access rights indicating which third-party entities are permitted to view representations of images stored in secure storage repository 106, for example to authenticate shared second copies of the images. In some embodiments, the access directory 114 may further include credential information indicating what credentials are required to be provided by the third parties to prove their identities. Also, in some embodiments different access privileges may be associated with different types of credentials. For example, third parties with higher level credentials may be able to view additional information about a stored image, such as image metadata, whereas third parties with more limited credentials may only be allowed to view a representation of a stored image.

FIG. 7 illustrates an input image gatekeeping engine that may be included in a cloud network, wherein the input image gatekeeping engine verifies a token associated with received image data matches encryption material provided to the mobile electronic device for use in generating tokens, wherein if the token matches the provided encryption material it can be affirmed that the image data was captured by the particular mobile electronic device, according to some embodiments.

In some embodiments, input image gatekeeping engine 110 may verify that the mobile electronic device 150 providing the image data and associated metadata 710 is a trusted type of mobile electronic device, such as one manufactured by a trusted entity. Also, input image gatekeeping engine 110 may verify that a token included in the image data and associated metadata 710 is an authentic token provided to a trusted mobile device. For example, token store 702 may include information for identifying tokens from various mobile electronic devices, such as device 1 tokens 704, device 2 tokens 706, and device N tokens 708. Token identification 712 may parse the attached metadata included with image data 710 to identify bits corresponding to a token inserted at the mobile electronic device using provided cryptographic information. Token evaluator 716 may search token store 702 for token information for tokens of trusted devices, such as devices 1 through N. Device identifier to token identifier 718 may then verify that the token included with the image data 710 is the appropriate token for the mobile electronic device that sent the image data. For example, token evaluator 716 may determine that the identified token is a token for device 2, and device identifier to token identifier comparison 718 may confirm that the device that provided the image data 710 was in fact device 2. Thus, the device identifier and token identifier match. In such a case, the image data 710 may be authenticated as coming from a particular device (e.g. device 2) as shown for 720. If there is not a match, input image gatekeeping engine 110 may decline to authenticate the image data 710 as shown for 722, in which case the image data 710 is not added to secure storge repository 106.

FIG. 8 illustrates an access directory updater that may be included in a cloud network, wherein the access directory updater receives sharing updates, sharing preferences, and/or social media relationship information and uses these received items of information to update a directory of which entities, and with which credentials, are authorized to use the image authentication features of the cloud network for which images, according to some embodiments.

In some embodiments, an access directory update may update entities included in access directory 114 as well as viewing privileged associated with the entities and also credentials associated with the entities. For example, photo sharing updates 802 may be used to update access directory 602. As an example, different sharing settings may be set using a user interface of the mobile electronic device, such as shown in FIG. 3. Also, an image owner may provide updated sharing preferences 804, such as a list of entities to be included (or removed) from access directory 114, as well as social media sharing settings. Additionally, image owner social media relationship information 806 may be used by access directory updater. For example, these inputs may be used by access directory updater 602 to generate access directory updates 808.

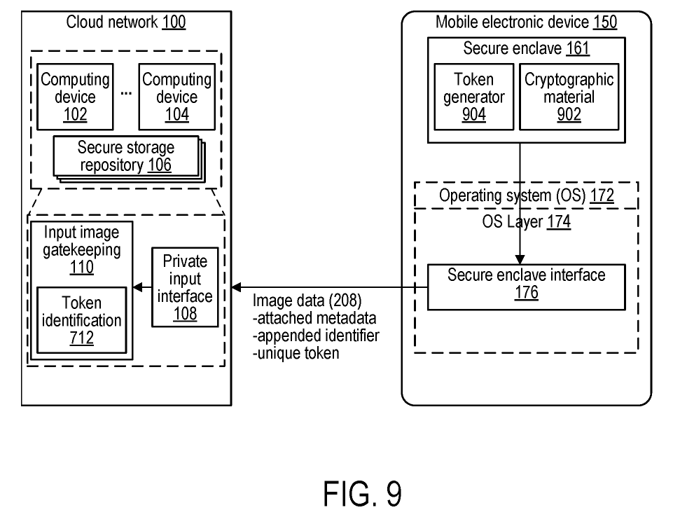

FIG. 9 illustrates tokens being appended to image data being forwarded via a secure communication channel between a secure enclave of a mobile electronic device and a secure storage repository of a cloud network, according to some embodiments.

As an example, cryptographic material 902 may be stored in (or otherwise accessible to) token generator 904 implemented in secure enclave 161 or secure enclave interface 176. The cryptographic material may have been provided by cloud network 100. Token store 702 of input image gatekeeping engine 110 may store a copy of the cryptographic material provided to various devices and may use this information to determine a relationship between an identified token and a device that was provided cryptographic material 902 for use in generating that specific token.

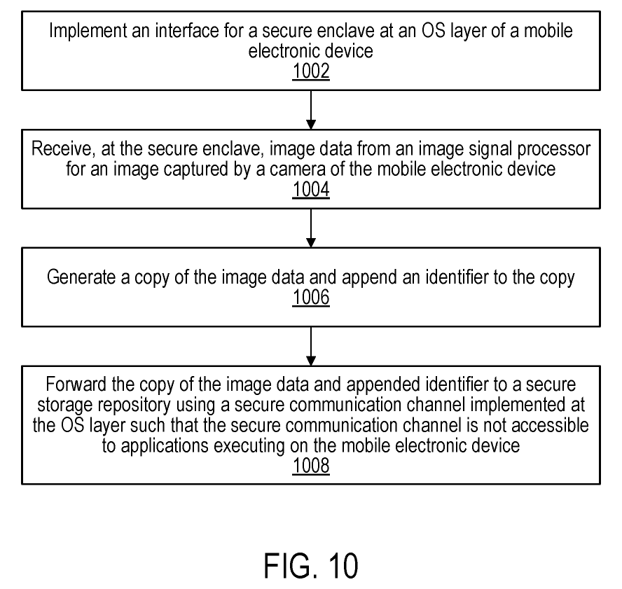

FIG. 10 is a flowchart illustrating operations performed at a mobile electronic device to generate copies of image data captured by an image sensor and to provide the copied image data to a secure storage repository of a cloud network, according to some embodiments.

At block 1002, a mobile electronic device implements a secure enclave and a secure enclave interface at an OS layer inaccessible to applications executing on the mobile electronic device. For example, secure enclave 161 and secure enclave interface 176 may be implemented on mobile electronic device 150.

At block 1004, the mobile electronic device receives, at the secure enclave, image data from an image signal processor for an image captured by a camera of the mobile electronic device. For example, image data 206 is received at secure enclave 161 from image signal processor 156.

At block 1006, the mobile electronic device generates, in the secure enclave a copy of the image data and appends an identifier to the copy of the image data. For example, as shown in FIG. 4 copy 1 (404) and copy 2 (418) are generated in secure enclave 161. Also, identifier attachment engine 410 appends an identifier on copy 1 (404) of the image data.

At block 1008, the copy of the image data and appended identifier is forwarded to a secure storage repository using a secure communication channel implemented at the OS layer such that the secure communication channel is not accessible to applications executing on the mobile electronic device. For example, as shown in FIG. 2, copy 1 (208) of the image data is forwarded to secure storage repository 106 via secure enclave interface 176, secure communication channel 202, and wireless transmitter 158.

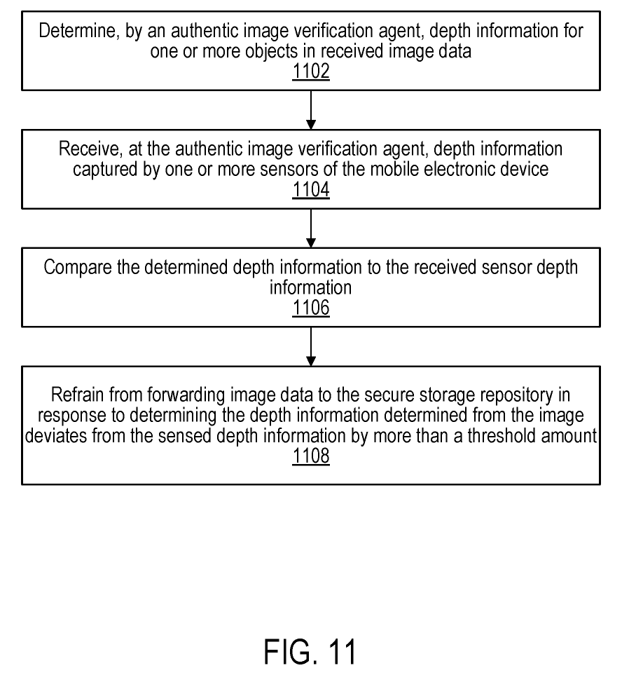

FIG. 11 is a flowchart illustrating operations performed by an authentic image verification agent of a secure enclave to reject image data that is deemed to not represent an image capture of a real-world scene or object, according to some embodiments.

In some embodiments, the mobile electronic device may further implement an authentic image verification agent 408 as shown in FIG. 4. For example, at block 1102, the authentic image verification agent determines depth information for one or more objects in the received image data.

At block 1104, the authentic image verification agent receives depth information captured by one or more sensors of the mobile electronic device, such as LiDAR sensors.

At block 1106, the authentic image verification agent compares the determined depth information to the received sensor depth information.

At block 1108, the authentic image verification agent refrains from forwarding the image data to the secure storage repository in response to determining the depth information determined from the image deviates from the sensed depth information by more than a threshold amount. For example, authentication verification agent 408 may refrain from forwarding image data to identifier attachment engine 410 if the image data can be verified to be authentic image data captured for a real-world scene.

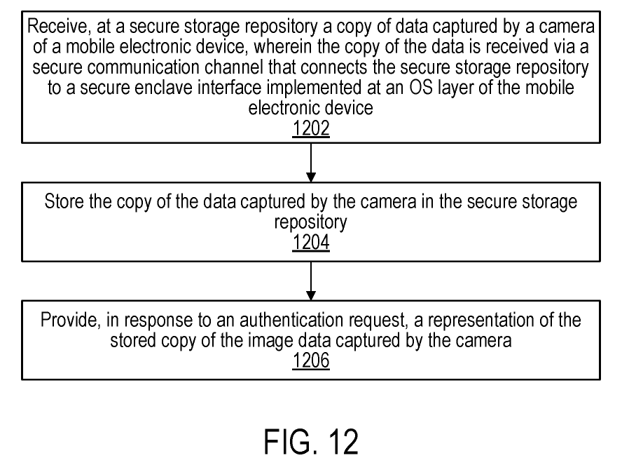

FIG. 12 is a flowchart illustrating operations performed by a cloud network implementing a secure storage repository, according to some embodiments.

At block 1202, a cloud network receives at a secure storage repository, via a private input interface, a copy of data captured by a camera of a mobile electronic device, wherein the copy of the data is received via a secure communication channel that connects the private input interface associated with the secure storage repository to a secure enclave interface implemented at an OS layer of the mobile electronic device.

At block 1204, the cloud network stores the copy of the data captured by the camera in the secure storage repository. And, at block 1206, provides, in response to an authentication request, a representation of the stored copy of the image data captured by the camera.

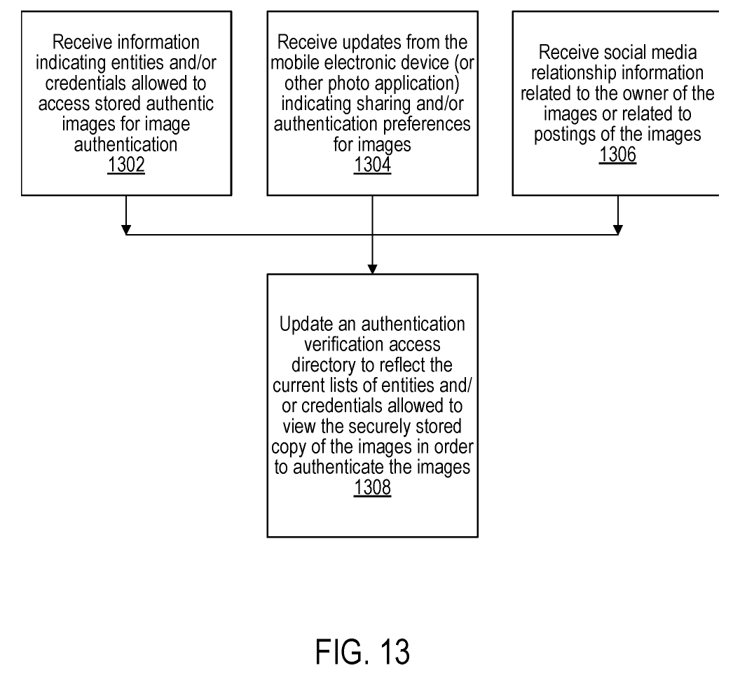

FIG. 13 is a flowchart illustrating operations to update an access directory for a secure storage repository of a cloud network, according to some embodiments.

At blocks 1302, 1304, and 1306, an access directory updater receives input information from various sources. For example, at block 1302 the access directory updater receives information indicating entities and/or credentials allowed to access stored authentic images for image authentication. At block 1304, the access directory updater receives updates from the mobile electronic device (or other photo application) indicating sharing and/or authentication preferences for images. Also, at block 1306, the access directory updater receives social media relationship information related to the owner of the images or related to postings of the images.

At block 1308, the access directory updater updates an authentication verification access directory to reflect the current lists of entities and/or credentials allowed to view the securely stored copy of the images in order to authenticate the images.

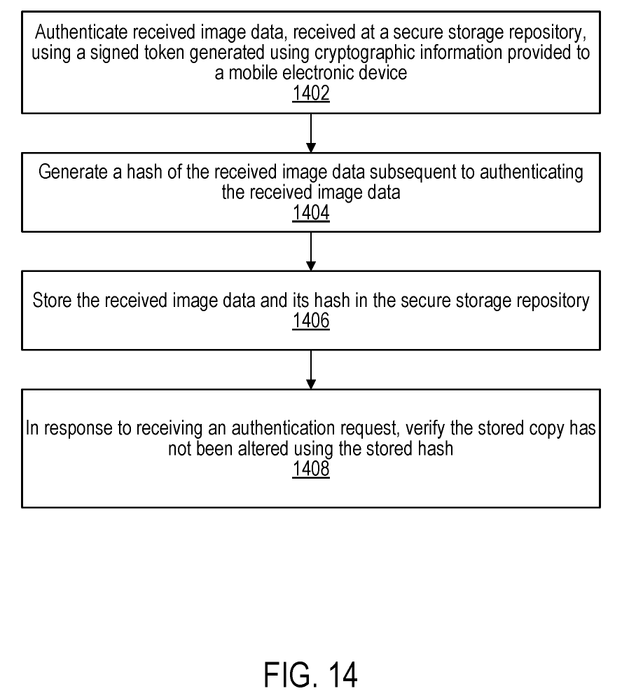

FIG. 14 is a flowchart illustrating operations performed at a secure storage repository to create a hash of stored image data and to use the hash to verify that the stored image data has not been altered, according to some embodiments.

At block 1402, a private input interface of a cloud network and/or an input gatekeeping engine authenticate received image data, received at a secure storage repository, using a signed token generated using cryptographic information provided to a mobile electronic device.

At block 1404, the private input interface of the cloud network and/or the input gatekeeping engine generates a hash of the received image data subsequent to authenticating the received image data. Also, at block 1406, the private input interface of the cloud network and/or the input gatekeeping engine stores the received image data and its hash in the secure storage repository.

At block 1408, a public authentication interface, in response to receiving an authentication request, verifies the stored copy has not been altered using the stored hash, and then provides a representation of the stored image data for use in performing authentication.

### Example Mobile Electronic Device

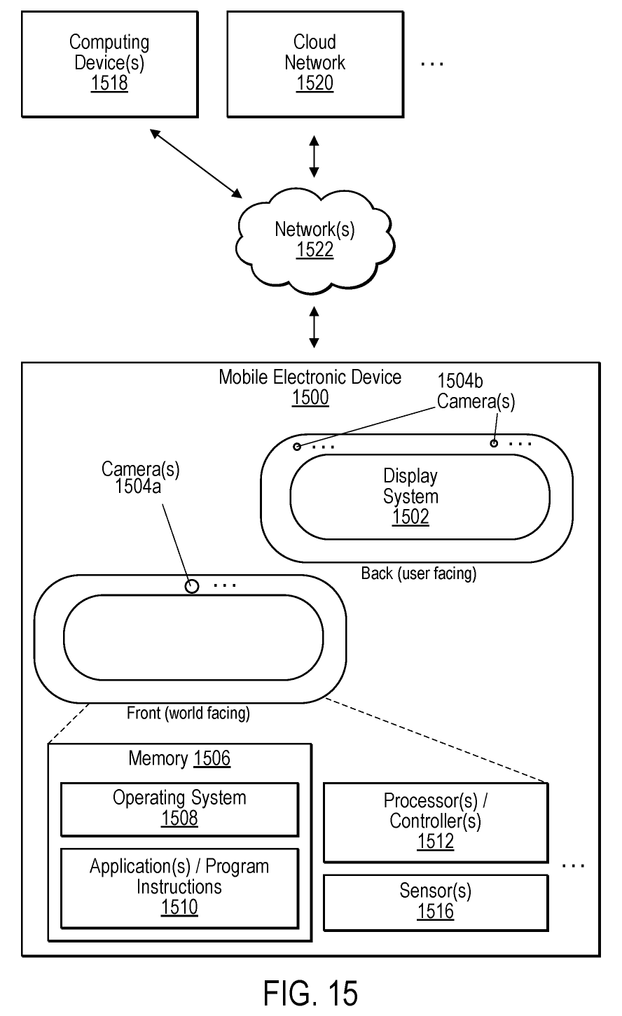

FIG. 15 illustrates a schematic representation of an example mobile electronic device 1500 that may include a camera (e.g., as described herein with respect to FIGS. 1-14), in accordance with some embodiments. In various embodiments, the mobile electronic device 1500 may be any of various types of devices, including, but not limited to, a head-mounted display, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, a television, a video recording device, or in general any type of computing or electronic device.

In some embodiments, the mobile electronic device 1500 may include a display system 1502 (e.g., comprising a display) and/or one or more cameras 1504. In some non-limiting embodiments, the display system 1502 and/or one or more front-facing cameras 1504a may be provided at a front side of the device 1500, e.g., as indicated in FIG. 15. Additionally, or alternatively, one or more user-facing cameras 1504b may be provided on a back side of the mobile electronic device 1500. In some embodiments comprising multiple cameras 1504, some or all of the cameras may be the same as, or similar to, each other. Additionally, or alternatively, some or all of the cameras may be different from each other. In various embodiments, the location(s) and/or arrangement(s) of the camera(s) 1504 may be different than those indicated in FIG. 15.

Among other things, the mobile electronic device 1500 may include memory 1506 (e.g., comprising an operating system 1508 and/or application(s)/program instructions 1510, as well as protected memory used by the secure enclave), one or more processors and/or controllers 1512 (e.g., comprising CPU(s), memory controller(s), display controller(s), image signal processor(s), secure enclave processor, and/or camera controller(s), etc.), and/or one or more sensors 1516 (e.g., orientation sensor(s), proximity sensor(s), and/or position sensor(s), etc.). In some embodiments, the mobile electronic device 1500 may communicate with one or more other devices and/or services, such as computing device(s) 1518, cloud network 1520, etc., via one or more networks 1522. For example, the device 1500 may include a network interface (e.g., network interface 1510) that enables the device 1500 to transmit data to, and receive data from, the network(s) 1522. Additionally, or alternatively, the mobile electronic device 1500 may be capable of communicating with other devices via wireless communication using any of a variety of communications standards, protocols, and/or technologies.

### Example Applications

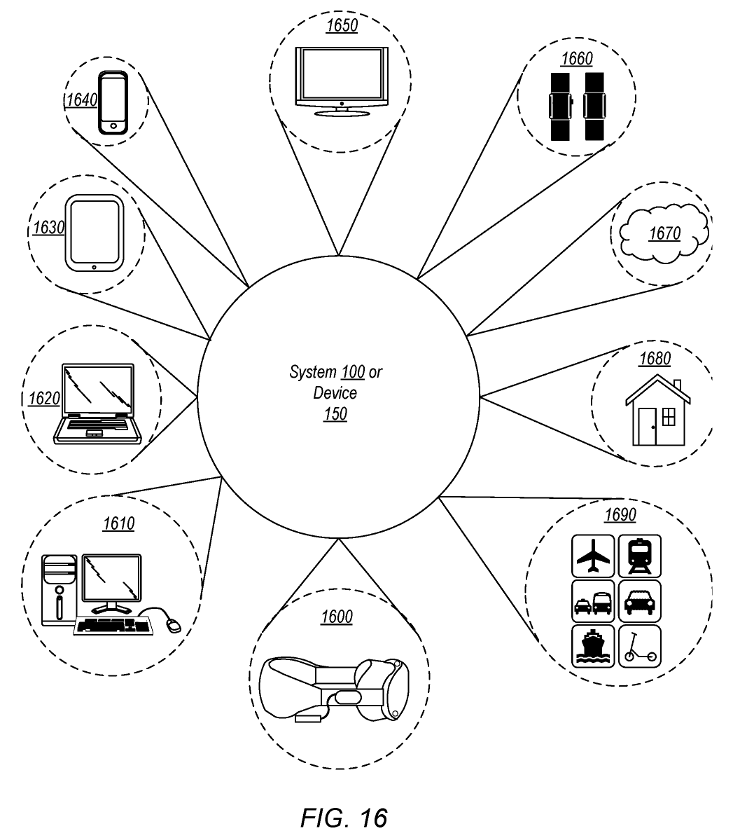

Turning now to FIG. 16, various types of systems that may include any of the circuits, devices, or systems that are discussed above are illustrated. System 100 or device 150 may be a cloud network system, such as cloud network 100, and may be a mobile electronic device, such as mobile electronic device 100. For example, system 100 or device 150 may be utilized as part of the hardware of systems such as head-mounted display device 1600, desktop computer 1610, laptop computer 1620, tablet computer 1630, cellular or mobile phone 1640, or television 1650 (or set-top box coupled to a television).Similarly, disclosed elements may be utilized in a wearable device 1660, such as a smartwatch or a health-monitoring device. Smartwatches, in many embodiments, may implement a variety of different functions—for example, cameras for image capture, access to email, cellular service, calendar, health monitoring, etc. A wearable device may also be designed solely to perform health-monitoring functions, such as monitoring a user’s vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System 100 or device 150 may also be used in various other contexts. For example, system 100 or device 150 may be utilized in the context of a server computer system, such as a dedicated server or on shared hardware that implements a cloud-based network 1670. Still further, system or device 1600 may be implemented in a wide range of specialized everyday devices, including devices 1680 commonly found in the home such as refrigerators, thermostats, security cameras, etc. The interconnection of such devices is often referred to as the “Internet of Things” (IoT). Elements may also be implemented in various modes of transportation. For example, system 100 or device 150 could be employed in the control systems, guidance systems, entertainment systems, etc. of various types of vehicles 1690.

The applications illustrated in FIG. 16 are merely exemplary and are not intended to limit the potential future applications of disclosed systems or devices. Other example applications include, without limitation: portable gaming devices, music players, data storage devices, unmanned aerial vehicles, etc.

### Example Computer System

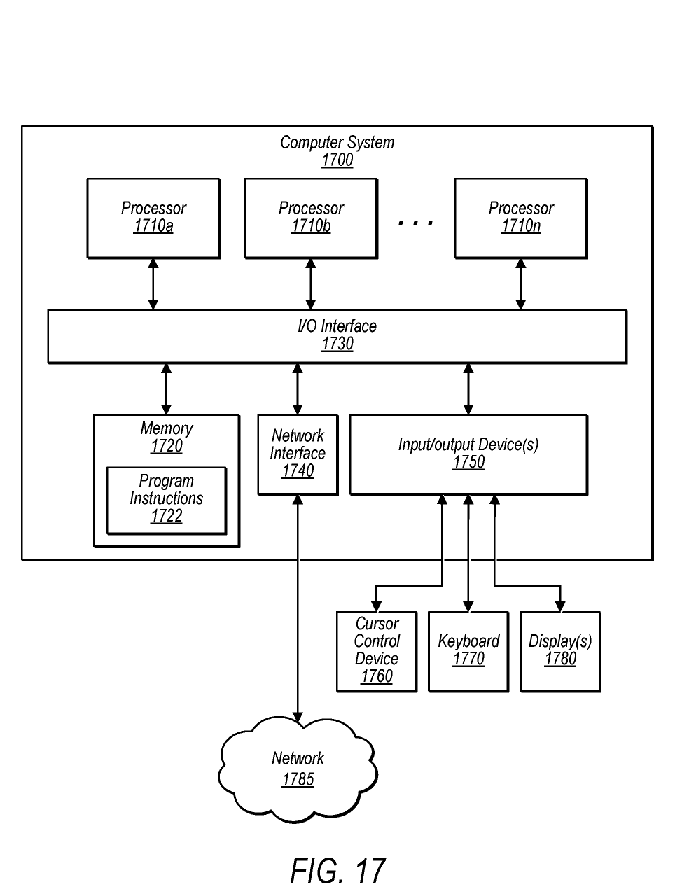

FIG. 17 illustrates exemplary computer system 1700 used to implement any of the computing devices and/or mobile electronic devices as described above with reference to FIGS. 1-16. In different embodiments, computer system 1700 may be any of various types of devices, including, but not limited to, a personal computer system, desktop computer, laptop, notebook, tablet, slate, pad, or netbook computer, handheld computer, workstation, network computer, a camera, a set top box, a mobile device, a consumer device, video game console, handheld video game device, application server, storage device, a television, a video recording device, a peripheral device such as a switch, modem, router, or in general any type of computing or electronic device.

In the illustrated embodiment, computer system 1700 includes one or more processors 1710 coupled to a system memory 1720 via an input/output (I/O) interface 1730. Computer system 1700 further includes a network interface 1740 coupled to I/O interface 1730, and one or more input/output devices 1750, such as cursor control device 1760, keyboard 1770, and display(s) 1780.

System memory 1720 may be configured to store program instructions 1722 and/or sensor data accessible by processor 1710. In various embodiments, system memory 1720 may be implemented using any suitable memory technology, such as static random access memory (SRAM), synchronous dynamic RAM (SDRAM), nonvolatile/Flash-type memory, or any other type of memory. In the illustrated embodiment, program instructions 1722 may be configured to implement a secure enclave incorporating any of the functionality described above. In some embodiments, program instructions and/or data may be received, sent or stored upon different types of computer-accessible media or on similar media separate from system memory 1720 or computer system 1700.

In one embodiment, I/O interface 1730 may be configured to coordinate I/O traffic between processor 1710, system memory 1720, and any peripheral devices in the device, including network interface 1740 or other peripheral interfaces, such as input/output devices 1750. In some embodiments, I/O interface 1730 may perform any necessary protocol, timing or other data transformations to convert data signals from one component (e.g., system memory 1720) into a format suitable for use by another component (e.g., processor 1710). In some embodiments, I/O interface 1730 may include support for devices attached through various types of peripheral buses, such as a variant of the Peripheral Component Interconnect (PCI) bus standard or the Universal Serial Bus (USB) standard, for example. In some embodiments, the function of I/O interface 1730 may be split into two or more separate components, such as a north bridge and a south bridge, for example. Also, in some embodiments some or all of the functionality of I/O interface 1730, such as an interface to system memory 1720, may be incorporated directly into processor 1710.

Network interface 1740 may be configured to allow data to be exchanged between computer system 1700 and other devices attached to a network 1785 (e.g., carrier or agent devices) or between nodes of computer system 1700. Network 1785 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1740 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1750 may, in some embodiments, include one or more display terminals, keyboards, keypads, touchpads, scanning devices, voice or optical recognition devices, or any other devices suitable for entering or accessing data by one or more computer systems 1700. Multiple input/output devices 1750 may be present in computer system 1700 or may be distributed on various nodes of computer system 1700. In some embodiments, similar input/output devices may be separate from computer system 1700 and may interact with one or more nodes of computer system 1700 through a wired or wireless connection, such as over network interface 1740.

As shown in FIG. 12, memory 1720 may include program instructions 1722, which may be processor-executable to implement any element or action described above. In one embodiment, the program instructions may implement the methods described above. In other embodiments, different elements and data may be included.

Computer system 1700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1700 may be transmitted to computer system 1700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow

What is claimed is:

1. A mobile electronic device, comprising:
a camera;
an image signal processor;
one or more additional processors; and
a memory, storing program instructions, that when executed using the one or more additional processors, cause the one or more additional processors to:
implement an operating system (OS) for the mobile electronic device; and
forward data from the image signal processor and an appended identifier to a secure storage repository, wherein the data and appended identifier are forwarded to the secure storage repository using a secure communication channel implemented at an OS layer below an application layer such that the secure communication channel is not accessible to applications executing on the mobile electronic device.

2. The mobile device of claim 1, further comprising:
a local storage,
wherein the program instructions, when executed using the one or more additional processors, further cause the one or more additional processors to:
generate a copy of the data, wherein the data to which the identifier is appended and forwarded to the secure storage repository is a first copy of the data; and
provide, to the application layer, a second copy of the data, wherein the second copy of the data is accessible to one or more of the applications executing on the mobile device.

3. The mobile electronic device of claim 1, wherein the program instructions, when executed using the one or more additional processors, further cause the one or more additional processors to:
receive, via a user interface of the mobile electronic device, an indication that a given image captured by the camera of the mobile electronic device is authorized for public sharing; and
send an indication to the secure storage repository to provide, when presented with the identifier, a representation of the securely stored first copy of the data,
wherein the first copy and the second copy of the data are usable to determine the second copy of the data is an authentic copy of original data from the image signal processor.

4. The mobile electronic device of claim 1, wherein the program instructions, when executed using the one or more additional processors, further cause the one or more additional processors to:
implement a secure enclave in the OS, at the OS layer below the application layer, wherein data in the secure enclave is not accessible to the applications executing on the mobile device;
receive, from the image signal processor, at the secure enclave, the data for an image captured by the camera; and
append, in the secure enclave, the identifier to the data,
wherein the secure communication channel connects the secure enclave to the secure storage repository at the OS layer.

5. The mobile electronic device of claim 4, wherein the program instructions, when executed using the one or more additional processors, further cause the one or more additional processors to:
append additional metadata to the data in the secure enclave, wherein the additional metadata comprises one or more of:
a date and/or time when the image was captured by the camera; or
a geographic location of the mobile electronic device when the image was captured by the camera.

6. The mobile electronic device of claim 4, wherein the program instructions, when executed using the one or more additional processors, further cause the one or more additional processors to:
implement a verification agent in the secure enclave, wherein the verification agent uses other sensor data captured in temporal proximity to the image by one or more other sensors of the mobile electronic device to verify that the data is of an authentic image.

7. The mobile electronic device of claim 6, wherein to determine the data is of an authentic image the program instructions, when executed using the one or more additional processors, cause the one or more additional processors to:
determine depth information for one or more objects in the image;
compare the determined depth information to depth data captured by the one or more other sensors of the mobile electronic device; and
refrain from submitting the image to the secure storage repository in response to determining the determined depth information deviates from the depth data by more than a threshold amount.

8. The mobile electronic device of claim 1, wherein the data from the image signal processor comprises one or more of:
an image;
a video; or
volumetric visual content.

9. A system comprising:
a secure storage repository; and
one or more computing devices storing program instructions, that when executed by the one or more computing devices, cause the one or more computing devices to:
receive from a mobile electronic device, via a secure communication channel, a copy of data captured by a camera of the mobile electronic device, wherein the secure communication channel connects the one or more computing devices to the mobile electronic device at an OS layer below an application layer such that the secure communication channel is not accessible to applications executing on the mobile electronic device;
store the copy of the data captured by the camera of the mobile electronic device in the secure storage repository; and
provide, in response to an authentication request, a representation of the stored copy of the data captured by the camera.

10. The system of claim 9, further comprising:
an additional storage repository,
wherein the one or more computing devices store program instructions that, when executed by the one or more computing devices, cause the one or more computing devices to:
receive from the mobile device, or another source, an additional copy of the data captured by the camera of the mobile electronic device via a separate interface, separate from the secure communication channel;
store the additional copy of the data captured by the camera of the mobile electronic device in the additional storage,
wherein the additional copy of the data captured by the camera stored in the additional storage is editable; and
wherein the copy of the data captured by the camera stored in the secure storage repository is not editable.

11. The system of claim 9, wherein the program instructions, when executed by the one or more computing devices, cause the one or more computing devices to:
compare metadata included with the authentication request to metadata stored in the secure storage repository for the copy of the data captured by the camera of the mobile electronic device,
wherein said providing the representation of the stored copy of the data captured by the camera is performed in response to determining a match between one or more items of metadata included with the authentication request and one or more items of metadata stored in the secure storage repository for the copy of the data captured by the camera.

12. The system of claim 11, wherein the one or more items of matching metadata comprise one or more of:
an identifier appended to the data captured by the camera stored in the secure storage repository and an identifier provided with the authentication request; or
a date and/or time the data was captured that is stored in the secure storage repository and a date and/or time provided with the authentication request.

13. The system of claim 9, wherein the program instructions, when executed by the one or more computing devices, cause the one or more computing devices to:
compare a credential or an identity of an entity making the request with a directory of entities and/or credentials authorized to be provided the representation of the stored copy of the data captured by the camera,
wherein said providing the representation of the stored copy of the data captured by the camera is performed in response to determining a match between the credential and/or the identity of the entity making the request with a given credential and/or a given entity included in the directory.

14. The system of claim 13, wherein the program instructions, when executed by the one or more computing devices, cause the one or more computing devices to:
receive updates from an owner of the data captured by the camera stored in the secure storage repository regarding entities and/or credentials authorized to be provided the representation of the stored copy of the data captured by the camera; and
update the directory based on the owner provided updates.

15. The system of claim 13, wherein the program instructions, when executed by the one or more computing devices, cause the one or more computing devices to:
receive updates from the mobile electronic device indicating images that have been authorized for public sharing; and
update the directory to allow representations of image data for the images authorized for public sharing to be provided in response to authentication requests.

16. The system of claim 13, wherein the program instructions, when executed by the one or more computing devices, cause the one or more computing devices to:
receive social media relationship information indicating entities having a relationship with an owner of the data captured by the camera stored in the secure storage repository; and
provide the representation of the stored copy of the data captured by the camera in response to an authentication request, wherein a determination to provide the representation is based on a given relationship between a requestor of the authentication request and the owner as indicated in the social media relationship information.

17. The system of claim 9, wherein a signed token is received via the secure communication channel with the copy of the data captured by the camera, wherein the signed token is appended to the data by an image signal processor of the mobile electronic device, and
wherein the program instructions when executed by the one or more computing devices, cause the one or more computing devices to:
authenticate the copy of the data captured by the camera as coming from a particular mobile electronic device which has been issued cryptographic information for generating the signed token.

18. The system of claim 9, wherein the program instructions, when executed by the one or more computing devices, cause the one or more computing devices to:
generate a hash of the received copy of the data captured by the camera of the mobile electronic device;
store the hash in the secure storage repository with the copy of the data captured by the camera of the mobile electronic device; and
verify using the stored hash, prior to providing the representation of the stored copy of the data captured by the camera, that the stored copy of the data captured by the camera has not been altered.

19. The system of claim 9, wherein the copy of the data captured by the camera comprises one or more of:
an image;
a video; or
volumetric visual content.

20. One or more non-transitory, computer-readable, storage media, storing program instructions that, when executed using one or more processors, cause the one or more processors to:
forward image data and an appended identifier to a secure storage repository, wherein the image data and the appended identifier are forwarded to the secure storage repository using a secure communication channel implemented at an OS layer below an application layer such that the secure communication channel is not accessible to applications executing at the application layer.
